(19) United States
(12) Patent Application Publication
(10) Pub. No.: US 2013/0041796 A1
(43) Pub. Date: Feb. 14, 2013

(54) APPLICATION GOVERNANCE PROCESS AND TOOL

(71) Applicants: James Matthew Eggert, Tinley Park, IL (US); Chad Lewis Marshall, North East, MD (US)

(72) Inventors: James Matthew Eggert, Tinley Park, IL (US); Chad Lewis Marshall, North East, MD (US)

(73) Assignee: Bank of America Corporation, Charlotte, NC (US)

(21) Appl. No.: 13/205,256

(22) Filed: Aug. 8, 2011

(51) Int. Cl. G06Q 40/00; G06Q 99/00

(52) U.S. Cl. 705/35; 705/317

(57) ABSTRACT

Managing application governance data may include receiving application governance data from multiple data servers, storing the received application governance data, and consolidating the received application governance data into a common format by executing a predefined rule set. Governance data may include one or more risk assessments for various applications within an enterprise and each of the risk assessments may be organized in one or more native formats. Managing application governance data may also include receiving a request for the consolidated application governance data from a user, filtering the consolidated application governance data according to the user's role, comparing the filtered application governance data against a configurable metric, and transmitting the filtered application governance data and the comparison to the user.

### TECHNICAL FIELD

The present disclosure generally relates to the management of applications, and more particularly to the management of risk associated with applications within an enterprise.

### BACKGROUND

Enterprises employ many applications to achieve various business objectives. Such applications must comply with various industry and government regulations to reduce the level of risk affecting the organization. Risk management and assessment affect business decisions made in various business sectors, such as the banking industry. Commercial entities continuously assess risk and monitor risk mitigation efforts to ensure risk compliance are at acceptable levels within the enterprise.

### SUMMARY

In accordance with the present disclosure, disadvantages and problems related to managing risk associated with applications within an enterprise may be reduced or eliminated.

According to one embodiment, managing application governance data includes receiving application governance data from multiple data servers, storing the received application governance data, and consolidating the received application governance data into a common format by executing a predefined rule set. In particular implementations, the governance data includes one or more risk assessments for various applications within an enterprise and each of the risk assessments may be organized in one or more native formats. In some embodiments, managing application governance data may also include receiving a request for the consolidated application governance data from a user, filtering the consolidated application governance data according to the user's role, comparing the filtered application governance data against a configurable metric, and transmitting the filtered application governance data and the comparison to the user.

Certain embodiments of the present disclosure may provide one or more technical advantages. A technical advantage of one embodiment includes maintaining application governance in a consolidated and consistent format across the enterprise. In particular embodiments, this provides an accurate and transparent perspective of risk assessments affecting particular applications. Another technical advantage of an embodiment includes automatically filtering consolidated application governance data to present a subset of the data according to the user's role in the organization. This enables users in an enterprise to evaluate and mitigate risks associated with applications within their respective control. Yet another technical advantage of an embodiment includes presenting a scorecard that visually identifies the results of a comparison of application governance data against configurable metrics establishing threshold values of compliance ranging from unacceptable levels to acceptable levels of compliance. This further assists users in prioritizing risk mitigation and compliance efforts. This may also provide management with the information necessary to create incentives for achieving particular risk mitigation milestones.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example environment for managing application governance data.

FIG. 2 illustrates an example embodiment of a governance module.

FIG. 3 illustrates an example embodiment of an interface for displaying application governance data in a management executive view.

FIG. 4 illustrates an example embodiment of an interface for displaying application governance data in an application owner view.

FIG. 5 illustrates an example embodiment of an interface for displaying a trending report for application governance data.

FIG. 6A illustrates a flow chart of an example embodiment for consolidating application governance data.

FIG. 6B illustrates a flow chart of an example embodiment for requesting consolidated application governance data.

### DETAILED DESCRIPTION

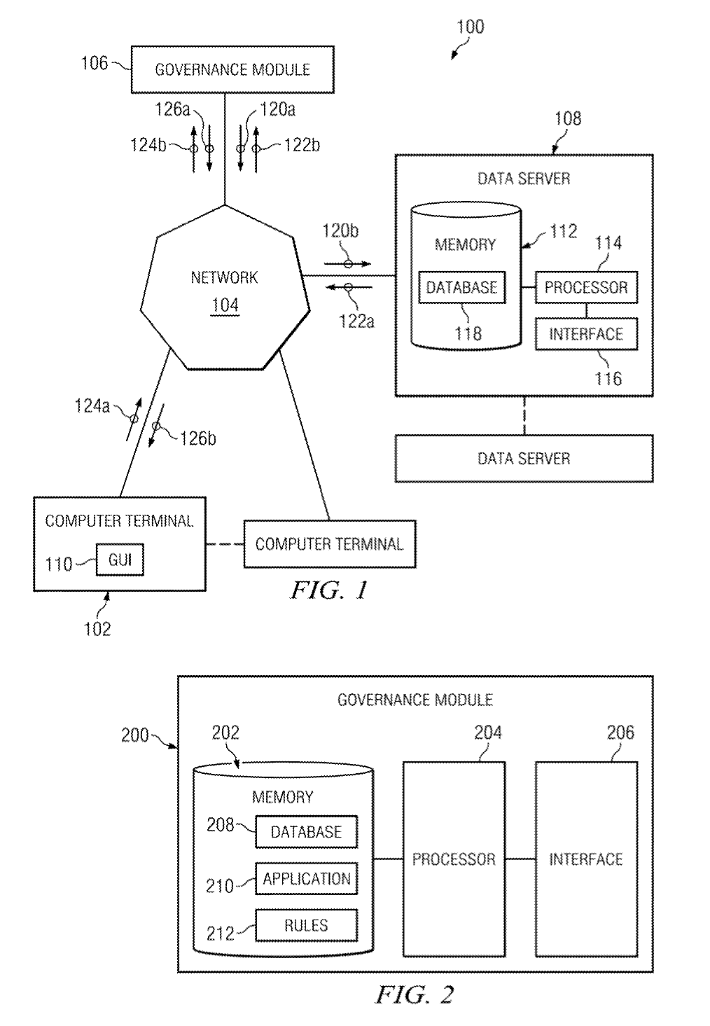

Embodiments of the present invention and its advantages are best understood by referring to FIGS. 1-6, like numerals being used for like and corresponding parts of the various drawings.

FIG. 1 illustrates a system 100 that consolidates application governance data for managing risk and compliance for various applications deployed in an enterprise. In particular embodiments, an application refers to hardware and/or software that enable an enterprise to perform core functions. System 100 includes one or more computer terminals 102 that communicate over a network 104 to consolidate application governance data and perform various other processing functions including filtering the data, comparing the data against various risk related configurable metrics, and displaying the results to a requesting user. Computer terminals 102 may interact with governance module 106 to conduct various processing activities. The governance module 106 interacts with data servers 108 to collect application governance data and to consolidate the application governance data for further processing.

Application governance is the set of procedures and processes that enable application owners to effectively reduce the risk that affects an enterprise by managing and mitigating the risk stemming from their respective applications. Application governance data may correspond to multiple risk assessments for each of many applications within an enterprise, and each risk assessment may have a unique format. An enterprise may have a collection of application owners distributed across multiple business units and lines of business that must be monitored for compliance and risk. Standards for compliance may be defined by various industry or regulatory standards established by the federal government or other governmental entities. By monitoring application governance data in a unified, consolidated format, an enterprise can easily access risk assessments and compliance measurements in real-time, thereby enabling the timely distribution of proper procedures and directives to application owners. Such a systematic management of risk reduces the risk associated with specific applications and thereby mitigates the risk to the entire enterprise.

In particular embodiments, a business unit at an enterprise may have multiple data servers 108 to maintain application governance data for its applications. The application governance data for a particular business unit may have a specific data format that is distinct from application governance data associated with other business units in the enterprise. Examples of application governance data include information that indicates whether applications comply with industry or regulatory standards including payment card industry compliance, data system security compliance, password compliance, and regulatory compliance as defined by various governmental entities. System 100 enables various decision makers to assess risk throughout the enterprise, evaluate the risk contributed by each application, and formulate a plan for mitigating risk at the management, executive, and application owner level. Consolidating application governance data ensures that the entire enterprise has immediate access to risk assessment that is substantially accurate and consistent throughout the organization.

Computer terminals 102 represent general purpose computers including appropriate hardware, control logic, and data that may be used to interface with other system components, such as governance module 106 or data servers 108, using network 104. For example, computer terminals 102 may represent work stations, laptops, netbooks, tablet computers, personal data assistants, (PDAs), mobile phones and any other suitable computing device. Computer terminals 102 may support a wide array of operations, including but not limited to, web browsing, word processing and managing application governance data. According to particular embodiments, computer terminals 102 may provide access, potentially through web-based interfaces, to information managed by other elements such as governance module 106 and data servers 108. As illustrated, computer terminals 102 may include a graphical user interface 110. Graphical user interface 110 represents any appropriate interface for receiving and displaying information to a user of system 100. Graphical user interface 110 may be any appropriate combination of hardware and/or software to facilitate a user's interaction with computer terminals 102.

Network 104 represents any suitable communications network operable to facilitate communication between the components of system 100, such as computer terminals 102, data servers 108, and governance module 106. Network 104 may include any interconnecting system capable of transmitting audio/video signals, data, messages or any other combination of the preceding. Network 104 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between components of system 100. Network 104 may include any combination of gateways, routers, hubs, switches, access points, base stations, wireless telephone systems and any other hardware, software or combination thereof.

Governance module 106 represents suitable hardware components, control logic, and data for receiving application governance data from data servers 108 corresponding to various business units of an enterprise and from computer terminals 102. As illustrated, governance module 106 may be communicatively coupled to other components of system 100, such as data servers 108 and computer terminals 102, by a network 104. In particular embodiments, governance module 106 may be operable to process the application governance data and facilitate presentation of the data in a consolidated format to various users at computer terminals 102. Governance module 106 will be discussed in further detail in FIG. 2.

Data servers 108 represent suitable hardware components, control logic, and data for managing application governance data. For example, data servers 108 may be any suitable combination of computer servers and networking devices, whether real or virtual. Data servers 108 may manage application governance data, which may include operational data and institutional risk data stemming from the design of particular applications. For example, data servers 108 may maintain application governance data related to various business units and risk assessments associated with specific applications deployed within the business units. In other embodiments, data servers 108 may be organized to maintain different types of risk associated with various business units within an enterprise. In certain embodiments, data servers 108 may maintain application governance data in various formats depending on the type of data being managed or the originating business unit.

As illustrated, data servers 108 may include various interconnected elements including a memory 112, a processor 114, and an interface 116. Memory 112 represents any suitable combination of volatile or non-volatile, local or remote devices suitable for storing information. For example, memory 112 may include random access memory (RAM), read only memory (ROM), magnetic storage devices, optical storage devices, or any other suitable information storage device or a combination of such devices. Memory 112 may maintain appropriate control logic and rules for controlling the operation of data servers 108. As illustrated, memory 112 may include a database 118 for storing and organizing various types of application governance data. In particular embodiments, database 118 represents a relational database for storing application governance data in an easily retrievable manner. For example, database 118 may represent a SQL database for storing various types of information including application governance data.

Processor 114 represents any hardware and/or software that communicatively couples to memory 112 and interface 116, and controls the operation and administration of data servers 108. For example, processor 114 may execute appropriate software to control the operation of data servers 108. Processor 114 may be a programmable logic device, a microcontroller, a microprocessor, any other appropriate processing device, or any suitable combination of the preceding.

Interface 116 represents any suitable device operable to receive information from network 104, transmit information through network 104, perform processing of received or transmitted information, communicate to other devices or any combination of the preceding. Interface 116 represents any port or connection real or virtual including any suitable hardware and/or software including protocol conversion and data processing capabilities to communicate through a LAN, WAN or other communication systems that allow data servers 108 to exchange information with network 104, computer terminals 102 and governance module 106. For example, interface 116 may receive requests for database transactions associated with database 118 from computer terminals 102. According to particular embodiments, interface 116 may receive application governance data from computer terminals 102 for appropriate processing by processor 114 and storage in database 118 of memory 112.

In exemplary embodiments, governance module 106 issues request 120 to data servers 108 through network 104 for application governance data. The application governance data may include multiple risk assignments associated with various business units. The application governance data may also vary in their data format. For example, one business unit may maintain their application governance data in a native format that is different from that of other business units. In other embodiments, the native data format of the data may depend on the type of risk assessment being managed. In response to request 120, data servers 108 transmit response 122, which includes the requested application governance data. Governance module 106 receives the application governance data and performs various functions on the data, such as consolidation. In other embodiments, governance module 106 may receive application governance data from computer terminals 102 using a similar process.

In particular embodiments, computer terminals 102 issue request 124 to governance module 106 through network 104 for processed application governance data. In response to request 124, governance module 106 may issue response 126, which includes the requested processed application governance data. In certain embodiments, governance module 106 consolidates application governance data received from a plurality of data servers and having different formats into a uniform, common format for presentation to a user. In other embodiments, the native data format of the data may depend on the type of risk assessment being managed.

Governance module 106 may conduct further processing upon receiving request 124 to tailor response 126 to established criteria to provide a context-specific view of risk and compliance across the enterprise. For example, the consolidated application governance data may be filtered to correspond to a specific user role. This may facilitate the display of application governance data at a level of granularity corresponding to the user's role within the organization, thereby enabling the user to obtain the risk related governance information relevant to that user's role within the enterprise and establish criteria for mitigating those identified risks. In some embodiments, the consolidated application data may be compared against configurable metrics. Such a comparison conveys to the user an assessment of whether particular applications are meeting established standards for compliance.

As discussed, the consolidated application governance data in response 126 may be tailored to the specific user issuing request 124. For example, request 124 may identify a user role within an organization and may correspond to an organizational role within the hierarchy of an enterprise. In some embodiments, each user role may have a specific view related to that role within the organization. Exemplary user roles may include manager, technical executive, and application owner. Such user roles may respectively correspond to a management view, a technical executive view, and an application owner view. A management view may provide a high-level view of the effectiveness of various application owners at mitigating the risk associated with their applications as organized under various technical executives. The management view may also provide a high-level view of the application governance data and levels of compliance across the enterprise. A technical executive view may provide a particular technical executive with the risk assessments for application owners that the technical executive manages. Finally, an application owner view may display all the applications that a particular application owner manages and provide an assessment of the risk assessments and level of compliance associated with each one of those applications. In particular embodiments, a application owner view may be more detailed, providing specifics related to that application owner's applications. A technical executive view or a management view may provide a less detailed view but instead reveal a broad view of risk compliance across the enterprise. According to particular embodiments, request 124 identifies a particular user role in its request for consolidated application governance data. In response, governance module 106 filters the consolidated application governance data for presentation in a view corresponding to the user role. As a result, response 126 may include the filtered, consolidated application data for presentation to a user at computer terminals 108.

As discussed above, the consolidated application governance data may be compared against configurable metrics that establish a range of compliance spanning from unacceptable to acceptable compliance levels. The response including the comparison may include a scorecard having a visual identifier indicating whether the filtered governance application data achieved a configurable threshold value of compliance. In particular embodiments, achieving a particular threshold value of compliance may be identified by color-coded scorecards specifying ranges of acceptable levels of compliance. For example, in particular embodiments, a red scorecard may indicate an unacceptable level of compliance for that risk assessment. Similarly, a yellow scorecard may indicate that a particular risk assessment for the application needs immediate attention while a green scorecard may indicate that a particular application is compliant with respect to that risk.

A component of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic. Any suitable logic may perform the functions of system 100 and the components within system 100.

While system 100 is illustrated as including specific components arranged in a particular configuration, it should be understood that various embodiments may operate using any suitable arrangement and collection of components capable of providing functionality such as that described.

FIG. 2 illustrates a system 200 as a particular embodiment of a governance module 106 that receives application governance data and processes it according to particular control logic. In a particular embodiment, system 200 represents a proprietary Bank of America governance module that facilitates management of risk and compliance associated with applications within an enterprise.

As illustrated, system 200 may include various interconnected elements including a memory 202, a processor 204, and an interface 206. Memory 202 stores, either permanently or temporarily, data, operational software, or other information for processor 204.

Memory 202 represents any suitable combination of volatile or non-volatile, local or remote devices suitable for storing information. For example, memory 202 may include RAM, ROM, magnetic storage devices, optical storage devices, or any other suitable information storage device or a combination of such devices. As illustrated, memory 202 includes a database 208, application 210, and rules 212 to facilitate processing of application governance data. Database 208 represents a relational database for storing and organizing various types of application governance data. In particular embodiments, database 208 may be a SQL database capable of organizing application governance data.

Application 210 generally refers to logic, rules, algorithms, code, tables and/or other suitable instructions for performing the described functions and operations of system 200. In certain embodiments, application 210 may facilitate the interaction of system 200 with data servers 108 and computer terminals 102 using network 104.

Rules 212 generally refer to logic, rules, standards, policies, limitations, tables, and/or other suitable instructions for processing the received application governance data from data servers 108 and/or computer terminals 102. Rules 212 may include logic to process the application governance data into a consolidated format, filter the data based on the user role, compare the data against various configurable metrics, and deliver the results in a consistent and unified format. In particular embodiments, configurable metrics may include one or more threshold values of compliance associated with each risk assessment category. For example, threshold values may be set at the 75% and 98% levels of compliance associated with achieving full compliance with a specific risk assessment category. Such threshold values may represent values ranging from unacceptable levels of compliance to acceptable levels of compliance for each risk assessment category. These threshold values are configurable according to regulatory standards or enterprise policies. In other embodiments, configurable metrics and thresholds may be defined according to various algorithms established by the enterprise.

Processor 204 represents any hardware and/or software that communicatively couples to memory 202 and interface 206, and controls the operation and administration of system 200. For example, processor 204 may execute appropriate instructions, control logic, and rules in application 210 to control the operation of system 200. According to particular embodiments, processor 204 may be a programmable logic device, a microcontroller, a microprocessor, any other appropriate processing device, or any suitable combination of the preceding.

Interface 206 represents any suitable device operable to receive information from a communication network, such as network 104, transmit information on the network, perform processing of received or transmitted information, communicate with other devices, or any combination of the preceding. Interface 206 may be any port or connection real or virtual including any suitable hardware and/or software including protocol conversion and data processing capabilities to communicate through a LAN, WAN or other communication systems that allow system 200 to exchange information with other devices over a communication network. For example, interface 206 may enable system 200 to communicate with other devices and systems such as computer terminals 102 and data servers 108 over network 104. In some embodiments, interface 206 may receive requests for application governance information as processed by processor 204 and stored in database 208 of memory 202. According to particular embodiments, interface 206 may receive application governance data from multiple data servers 108 and/or computer terminals 102. Following processing by system 200, interface 206 may also receive requests for the processed application governance data from computer terminals 102.

In operation, processor 204 interacts with interface 206 to receive governance data from a plurality of data servers 108. The application data received from the various data servers 108 may have different formats according to particular formats used by the business units and the type of risk being tracked. Processor 204 may also be operable to store the received application governance data in database 208 in memory 202. In particular embodiments, processor 204 consolidates the received application data into a common format for storage in database 208. Processor 204 may execute appropriate control logic as defined by application 210 to perform the conversion from various native application governance data formats into a consolidated common format for storage in database 208. In particular embodiments, processor 204 consolidates the received application governance data into a common format by executing a predefined rule set. The predefined rule set may be derived from rules 212 of memory 202. In some embodiments, the predefined rule set may outline the proper procedure for converting the various native formats of application governance data and the risk assessments embedded within the application governance data into the common format.

In certain embodiments, processor 204 receives a request from various computer terminals 102 on interface 206 for the delivery of consolidated application governance data. Computer terminals 102 may use a graphical user interface 110 to issue such requests. In particular embodiments, the graphical user interface 110 accesses a web interface for communicating with an internal enterprise website developed using Microsoft .NET code, active server pages, and one or more databases. In response to the request for consolidated application governance data, processor 204 may execute specific control logic defined by application 210 to filter the consolidated application governance data residing in database 208 according to the user role identified in the request.

Processor 204 may also execute specific control logic within application 210 to compare the filtered application governance data against configurable metrics. In particular embodiments, a configurable metric represents a threshold value of compliance associated with each risk assessment. The configurable metrics may establish levels of acceptable compliance. Such comparisons against the configurable metric allow system 200 to provide users with information related to acceptable or unacceptable levels of compliance as established by management or various industry or governmental regulations. Processor 204 may also execute appropriate control logic within application 210 to transmit the filtered application governance data and the comparison to computer terminals 102 for viewing by a particular user using interface 206. As discussed above, the consolidated application governance data may be displayed in particular views that correspond to the user role and identify achieving various levels of compliance.

While system 200 is illustrated as including specific components arranged in a particular configuration, it should be understood that various embodiments may operate using any suitable arrangement and collection of components capable of providing functionality such as that described.

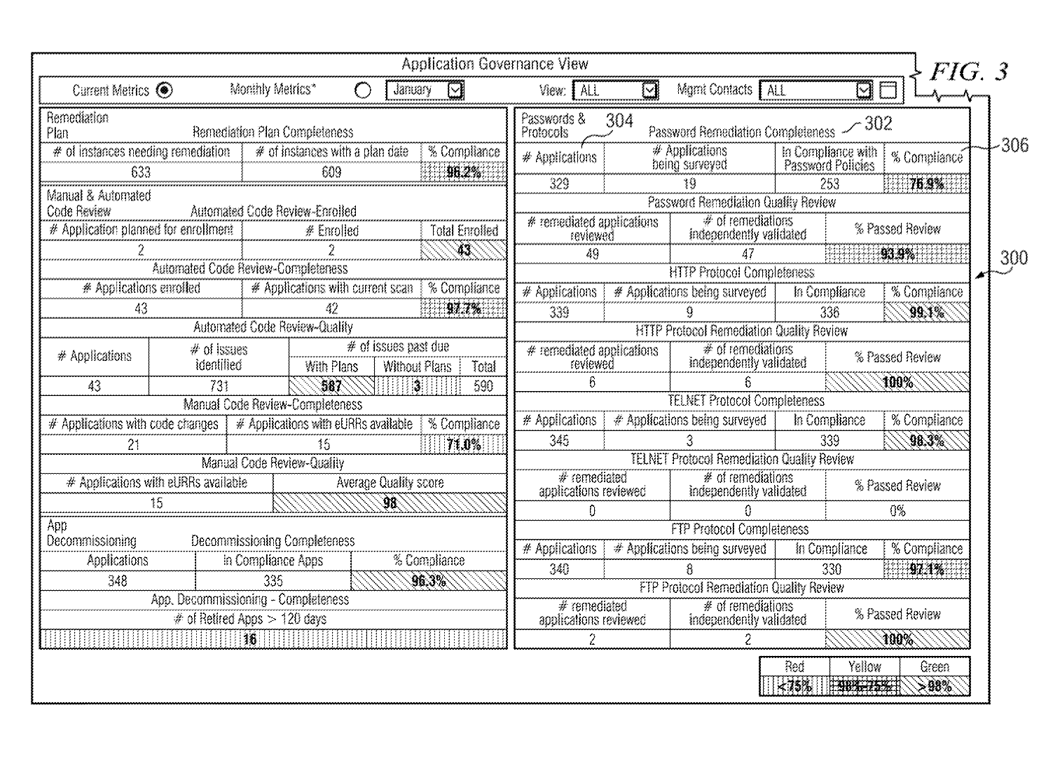

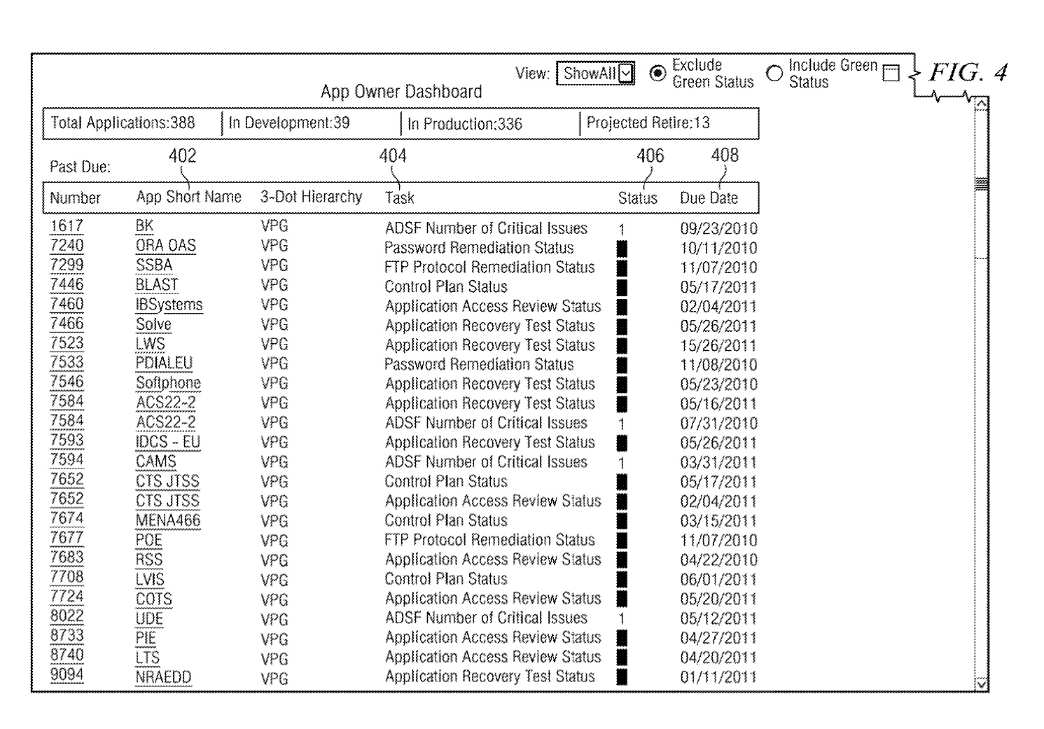

FIG. 3 illustrates a screenshot 300 of an example interface for displaying application governance data. In the exemplary screenshot, application governance data is displayed in a management executive view. Screenshot 300 may be one embodiment of an interface accessible to a category of users (e.g., managers) at various computer terminals 102 for receiving governance data for applications supervised by the category of users. As shown, screenshot 300 displays a management executive view that provides risk assessments for a collection of applications under a particular manager's control. Screenshot 300 may include a number of fields such as risk assessment field 302, number of applications field 304, and percentage of compliance field 306. In the illustrated embodiment, the risk assessment field 302 specifies the particular risk assessment being tracked by management. The number of applications field 304 specifies the number of applications tracked for the identified risk assessment. As illustrated, the risk assessment field 302 may contain a value of “password remediation completeness” and the associated number of applications tracked may have a value of 329. This expression of values establishes that 329 applications have been evaluated for compliance with the “password remediation completeness” risk assessment. As shown, the percentage of compliance field 306 specifies the level of compliance associated with the risk assessment. In the illustrated example, the level of compliance for “password remediation completeness” is 76.9% of 329 applications evaluated. In particular embodiments, specific threshold levels of compliance may cause certain colors to be displayed. For example, as depicted in screenshot 300, a green background for the percentage of compliance field 306 visually indicates a compliance level of 98% or above. Similarly a red background may be used for a compliance level less than 75% and a yellow background may be used for compliance values in between 75% and 98%. As discussed above, these color-coded compliance thresholds are configurable and facilitate quick identification of those risk assessments that are within an acceptable or unacceptable range of risk tolerance. In particular embodiments, the color-coded depiction of a comparison of compliance values against threshold compliance values may be referred to as a scorecard view. Screenshot 300 may also display a plurality of other fields to provide information about other risk assessments and other metrics. Accordingly, screenshot 300 demonstrates an exemplary embodiment of a management executive view that may be displayed to manager who is responsible for mitigating risk associated with applications belonging to more than one application owner.

As discussed above, screenshot 300 or variations thereof may be displayed upon request by a user having a managerial user role. For example, a request by a manager at computer terminals 102 for application governance data may cause governance module 106 to filter the consolidated application governance data to match the user role and display the filtered data in the format shown in screenshot 300. In particular embodiments, screenshot 300 may be presented using a graphical user interface 110 of computer terminals 102 over a web interface or tool.

FIG. 4 illustrates a screenshot 400 of an example interface for displaying application governance data. In the exemplary screenshot, application governance data is displayed in a application owner view. Screenshot 400 may be one embodiment of an interface accessible to a category of users (e.g., application owners) at various computer terminals 102 for receiving governance data for applications controlled or owned by a particular individual. As shown, screenshot 400 displays an application owner view that provides information regarding risk assessments for applications under that application owner's control. Screenshot 400 may include a number of fields such as application short name field 402, task field 404, status field 406, and due date field 408. In the illustrated embodiment, the short name field 402 specifies the abbreviated name for a particular application. A particular application may correspond to a specific line of business or be used across multiple lines of business or the enterprise. The task field 404 specifies the name of the risk assessment being tracked for the identified application. For example, “password remediation status” may be a task that is tracked using embodiments of the present disclosure. The status field 406 specifies the level of compliance by an application in terms of complying with threshold values of compliance for task. Depending on the task being tracked, the status field may specify a specific number or a level of compliance. In particular embodiments, specific levels of compliance may cause certain colors to be displayed. The due date field 408 specifies the deadline to remedy a particular risk associated with an application. In some embodiments, if the due date has passed, status field 406 may indicate an unacceptable level of compliance using a value and/or a color. Screenshot 400 may also display a plurality of other fields to provide information about applications, such as identification numbers and categories associated with an application. Accordingly, screenshot 400 demonstrates an exemplary embodiment of an application owner view that may be displayed to an application owner who is directly responsible for mitigating risk associated with one or more applications.

As discussed above, screenshot 400 or variations thereof may be displayed upon request by a user having an application owner user role. For example, a request by an application owner at computer terminals 102 for application governance data may cause governance module 106 to filter the consolidated application governance data to match the user role and display the filtered data in the format shown in screenshot 400. In particular embodiments, screenshot 400 may be presented using a graphical user interface 110 of computer terminals 102 over a web interface or tool.

Other embodiments may include a similar interface for displaying application governance data in a application owner view that provides greater detail than the executive management view and the technical executive view. For example, a manager in an enterprise may supervise one or more technical executives, who in turn oversee one or more application owners and their respective applications for risk compliance. Accordingly, an interface for displaying application governance data in a technical executive view may provide a technical executive, with information for risk assessments corresponding to those applications under his oversight, regardless of the specific application owners associated with the applications.

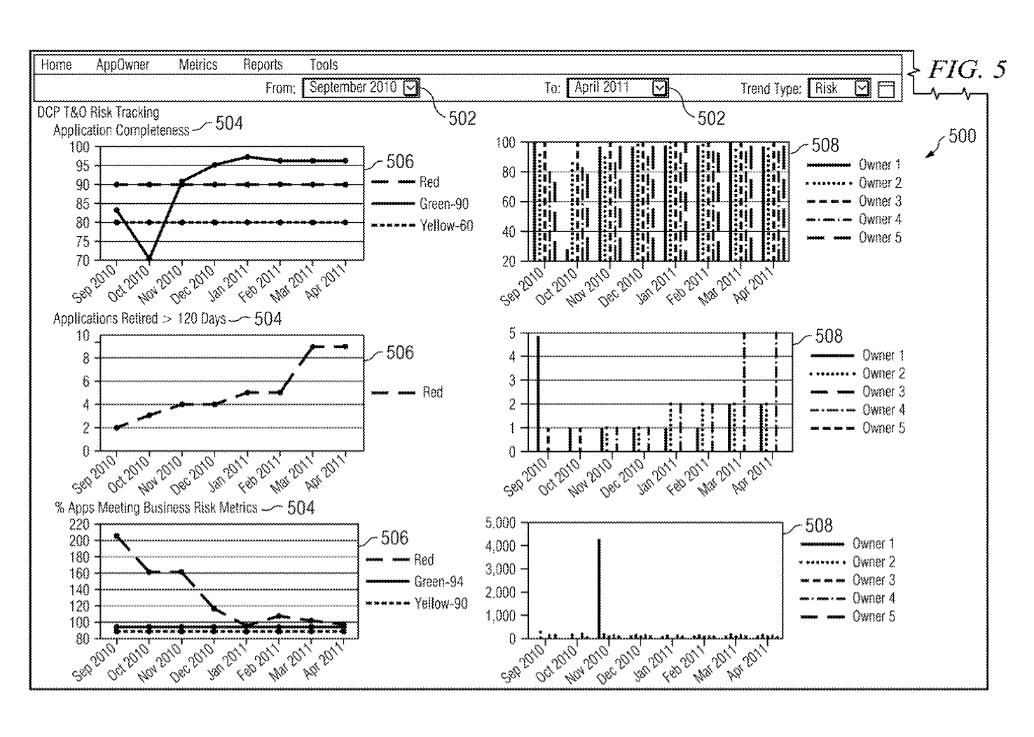

FIG. 5 illustrates an example screenshot 500 of an example interface for displaying a trending report for application governance data. A trending report tracks changes to application governance data over a specified period of time. As illustrated, a trending report may be depicted graphically. In particular embodiments, a trending report may graphically illustrate levels of compliance over a specified range of time.

Screenshot 500 includes a number of components for visually depicting a trending report including time range 502, trending categories 504, line graphs 506, and bar graphs 508. As illustrated, time range 502 provides an interface for the user to specify a desired time range for the data displayed in the trending report. For example, a user at computer terminals 102 may request a trending report spanning from September 2010 to April 2011. Trending categories 504 represent specific categories for depicting trending of application governance data over time. For example, trending categories may include application completeness, applications retired greater than 120 days, and percentage of applications meeting business risk metrics. In particular embodiments, application completeness may refer to the change in risk compliance over time based on various threshold values. Applications retired greater than 120 days may refer to applications that have been closed for over 120 days. Finally, percentage of applications meeting business risk metrics may refer to a value that represents the percentage of applications satisfying predefined business risk metrics. Business risk metrics may be specified by the enterprise or particular business units of the enterprise. Each of these trending categories has an associated line graph 506 and a bar graph 508. As illustrated, line graphs 506 depict aggregate information pertaining to the each of the trending categories as they change over the specified time across the enterprise. Bar graphs 508, however, depict trending categories as they apply to specific application owners or technical executives in the enterprise.

In exemplary embodiments, screenshot 500 may be displayed upon request by a user. For example, a request by an application owner at computer terminals 102 for trending report data may cause governance module 106 to process the consolidated application governance data to graphically display the filtered data in various graphs, such as the graphs depicted in screenshot 500. In particular embodiments, screenshot 500 may be presented using a graphical user interface 110 of computer terminals 102 over a web interface or tool.

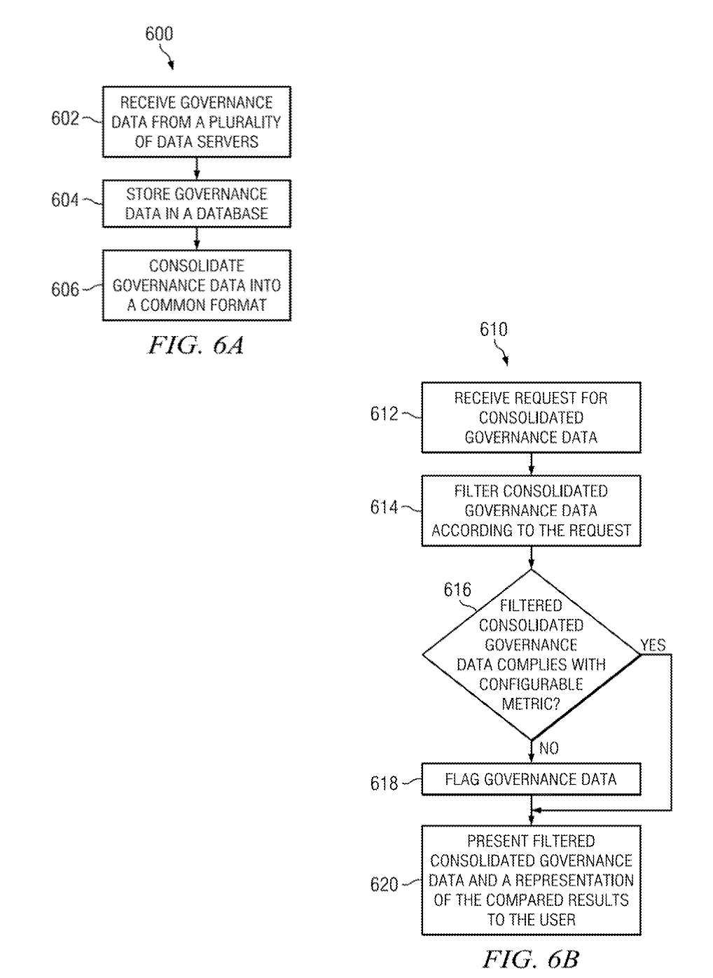

FIG. 6A illustrates a flow chart 600 for consolidating application governance data associated with an enterprise. In operation, the process depicted in flow chart 600 begins at step 602 when application governance data is received from a plurality of data servers. For example, governance module 106 may receive application governance data existing in various native formats from database server 108. Next, in step 604, embodiments of the present disclosure may store the governance data in a database, such as database 208 at governance module 106. Finally, the application governance data may be consolidated into a common format in step 606. In particular implementations, this step involves executing a predefined rule set to perform the conversion from various native application governance data formats into a consolidated common format for storage in database 208. As discussed above, the predefined rule set may be defined by the enterprise and may be derived from rules 212 of memory 202.

While flow chart 600 is illustrated as including specific steps arranged in a particular sequence, it should be understood that various embodiments may operate using any suitable arrangement and collection of steps capable of providing functionality such as that described. Accordingly, modifications, additions, or omissions may be made to flow chart 600 as appropriate.

FIG. 6B illustrates a flow chart 610 for consolidating application governance data associated with an enterprise. In operation, the process depicted in flow chart 610 begins at step 612 when a request for consolidated governance data is received. In particular implementations, a request for consolidated governance data may be received from computer terminals 102 using network 104. The request may include a user role corresponding to a user of computer terminals 102. For example, a user may be a manager, technical executive, or application owner. Next in step 614, the consolidated governance data is filtered according to the request. Accordingly, this step may include filtering the consolidated governance data to provide a subset of consolidated governance data associated with the user role identified in the request.

Next, in step 616, the filtered consolidated governance data is compared against configurable metrics. As discussed above, a configurable metric may establish a range of compliance thresholds spanning from unacceptable to acceptable compliance levels. Step 616 may facilitate comparison against more than one configurable metric. For example, one configurable metric might be established at a level of 75% compliance while another configurable metric might be established at a level of 98% compliance. In particular implementations, compliance with a configurable metric may be defined as exceeding the established threshold value. For example, if the filtered consolidated governance data exceeds an established 98% compliance threshold, the process may proceed to step 620 for presentation to the user. However, if the data falls below the 98% compliance threshold, the data may be flagged in governance data 618 for presentation in a different manner.

Finally, in step 620 the filtered consolidated governance data and the results of the comparison, including any flags, may be sent to the requesting user. In particular implementations, computer terminals 102 may receive this information and be configured to present the information using graphical user interface 110. For example, the information may be presented in one or more formats such as those depicted in screenshots 300 and 400. Computer terminals 102 may also be operable to display a representation of the comparison and flagging performed in steps 616 and 618 by color-coding the results in a scorecard. As discussed above, the results of the comparison may be represented in a scorecard having a visual identifier indicating whether the filtered governance application data achieved a configurable threshold value of compliance. For example, a red scorecard may indicate an unacceptable level of compliance (e.g., not exceeding an established threshold) for a particular risk assessment for an application. Likewise, a yellow scorecard may indicate that a particular risk assessment for the application needs immediate attention while a green scorecard may indicate that a particular application is near fully compliant with respect to that risk.

While flow chart 610 is illustrated as including specific steps arranged in a particular sequence, it should be understood that various embodiments may operate using suitable arrangement and collection of steps capable of providing functionality such as that described. Accordingly, modifications, additions, or omissions may be made to flow chart 610 as appropriate.

In particular implementations, embodiments may employ processes similar to those discussed in flow chart 600 and 610 to provide trending reports, such as the trending report shown in screenshot 500.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Certain embodiments of the present disclosure may provide one or more technical advantages. A technical advantage of one embodiment includes maintaining application governance in a consolidated and consistent format across the enterprise.

In particular embodiments, this provides an accurate and transparent perspective of risk assessments affecting particular applications. Another technical advantage of an embodiment includes automatically filtering consolidated application governance data to present a subset of the data according to the user's role in the organization. This enables users in an enterprise to evaluate and mitigate risks associated with applications within their respective control. Yet another technical advantage of an embodiment includes presenting a scorecard that visually identifies the results of a comparison of application governance data against configurable metrics establishing threshold values of compliance ranging from unacceptable levels to acceptable levels of compliance. This further assists users in prioritizing risk mitigation and compliance efforts. This may also provide management with the information necessary to create incentives for achieving particular risk mitigation milestones.

Although the present disclosure has been described in detail, it should be understood that various changes, substitutions, and alterations can be made hereto without departing from the scope of the invention as defined by the appended claims.

1. An apparatus, comprising:
an interface operable to receive application governance data from a plurality of data servers, wherein the governance data comprises one or more risk assessments for a plurality of applications within an enterprise, each of the risk assessments organized in one or more native formats;
a memory operable to store the received application governance data; and
a processor communicatively coupled to the interface and the memory, the processor operable to consolidate the received application governance data into a common format by executing a predefined rule set.

2. An apparatus of claim 1, wherein the interface is further operable to receive a request for the consolidated application governance data from a user and the request comprises a user role, and wherein the processor is further operable to:
filter the consolidated application governance data according to the user role;
compare the filtered application governance data against a configurable metric; and
transmit the filtered application governance data and the comparison to the user.

3. An apparatus of claim 2, wherein the configurable metric comprises a configurable threshold value of compliance associated with each risk assessment.

4. An apparatus of claim 3, wherein the comparison comprises a scorecard having a visual identifier that indicates whether the filtered governance application data achieves the configurable threshold value of compliance.

5. An apparatus of claim 1, wherein the one or more risk assessments are associated with at least one of the following: payment card industry compliance, data systems security, password compliance, and regulatory compliance.

6. An apparatus of claim 1, wherein the predefined rule set comprises instructions that, when executed by the processor, convert the one or more risk assessments organized in the one or more native formats into the common format.

7. An apparatus of claim 1, wherein the interface is further operable to receive a trending request for the consolidated application governance data from a user and the trending request comprises a time range and wherein the processor is further operable to:
filter the consolidated application governance data based on the time range;
generate a graphical representation of the filtered application governance data for each of the one or more risk assessments over the time range; and
transmit the graphical representation to the user.

8. A method, comprising:
receiving application governance data from a plurality of data servers, wherein the governance data comprises one or more risk assessments for a plurality of applications within an enterprise, each of the risk assessments organized in one or more native formats;
storing the received application governance data; and
consolidating, using a processor, the received application governance data into a common format by executing a predefined rule set.

9. The method of claim 8, further comprising:
receiving a request for the consolidated application governance data from a user, the request comprising a user role;
filtering, using the processor, the consolidated application governance data according to the user role;
comparing filtered application governance data against a configurable metric; and
transmitting filtered application governance data and the comparison to the user.

10. The method of claim 9, wherein the configurable metric comprises a configurable threshold value of compliance associated with each risk assessment.

11. The method of claim 10, wherein the comparison comprises a scorecard having a visual identifier that indicates whether the filtered governance application data achieves the configurable threshold value of compliance.

12. The method of claim 8, wherein the one or more risk assessments are associated with at least one of the following: payment card industry compliance, data systems security, password compliance, and regulatory compliance.

13. The method of claim 8, wherein the predefined rule set comprises instructions to convert the one or more risk assessments organized in the one or more native formats into the common format.

14. The method of claim 8, further comprising:
receiving a trending request for the consolidated application governance data from a user, the trending request comprising a time range;
filtering using the processor, consolidated application governance data based on the time range;
generating a graphical representation of the filtered application governance data for each of the one or more risk assessments over the time range; and
transmitting graphical representation to the user.

15. A non-transitory computer-readable medium comprising instructions, the instructions operable, when executed by a processor, to:
receive application governance data from a plurality of data servers wherein the governance data comprises one or more risk assessments for a plurality of applications within an enterprise, each of the risk assessments organized in one or more native formats;
store the received application governance data; and
consolidate the received application governance data into a common format by executing a predefined rule set.

16. The non-transitory computer-readable medium of claim 15, wherein the instructions are further operable when executed to:
receive a request for the consolidated application governance data from a user, the request comprising a user role;
filter the consolidated application governance data according to the user role;
compare the filtered application governance data against a configurable metric; and
transmit the filtered application governance data and the comparison to the user.

17. The non-transitory computer-readable medium of claim 16, wherein the configurable metric comprises a configurable threshold value of compliance associated with each risk assessment.

18. The non-transitory computer-readable medium of claim 17, wherein the comparison comprises a scorecard having a visual identifier that indicates whether the filtered governance application data achieves the configurable threshold value of compliance.

19. The non-transitory computer-readable medium of claim 15, wherein the predefined rule set comprises instructions to convert the one or more risk assessments organized in the one or more native formats into the common format.

20. The non-transitory computer-readable medium of claim 15, wherein the instructions are further operable when executed to:
receive a trending request for the consolidated application governance data from a user, the trending request comprising a time range;
filter the consolidated application governance data based on the time range;
generate a graphical representation of the filtered application governance data for each of the one or more risk assessments over the time range; and
transmit the graphical representation to the user.
